(19) United States
(12) Patent Application Publication
(10) Pub. No.: US 2015/0142315 A1
(43) Pub. Date: May 21, 2015

(54) MARINE RISER MANAGEMENT SYSTEM AND AN ASSOCIATED METHOD

(71) Applicant: General Electric Company, Schenectady, NY (US)

(72) Inventors: Judith Ann Guzzo, Niskayuna, NY (US); John William Carbone, Ballston Spa, NY (US); Li Zhang, Clifton Park, NY (US); Shaopeng Liu, Schenectady, NY (US)

(73) Assignee: General Electric Company, Schenectady, NY (US)

(21) Appl. No.: 14/081,173

(22) Filed: Nov. 15, 2013

(51) Int. Cl. E21B 47/00; E21B 49/00; G01V 99/00

(52) U.S. Cl. CPC E21B 47/0001; G01V 99/00; E21B 49/003
USPC 702/6

(57) ABSTRACT

In accordance with one aspect of the present technique, a method is disclosed. The method includes receiving sensor data from a first set of sensors mechanically coupled to a first riser joint of a marine riser. The method also includes analyzing the sensor data to determine a condition of the first riser joint and determining whether the condition satisfies a transmission criterion. The method further includes sending a notification including the condition to an on-vessel monitor communicatively coupled to the marine riser in response to determining that the condition satisfies the transmission criterion.

### BACKGROUND

The subject matter disclosed herein generally relates to a marine riser management system. More specifically, the subject matter relates to a system and a method for analyzing sensor data received from sensors coupled to a marine riser and transmitting the sensor data to an on-vessel monitor based on the analysis.

Marine risers are components used in offshore drilling of hydrocarbons and production operations conducted from a vessel on the ocean surface. Marine risers are vertical structures that extend miles in length connecting the vessel and a well head on the ocean floor. The marine riser needs to be successfully deployed into the ocean and maintained over their lifespan (e.g., 20 years) in challenging environments while meeting safety and regulatory requirements.

Existing riser management systems include sensors that are coupled to a marine riser. Such systems have numerous problems due to limitations in the retrieval of sensor data by monitors deployed on the vessel. For example, the monitor receives sensor data from loggers coupled to the sensors. Such systems are disadvantageous as the loggers include large amounts of non-readily interpreted sensor data. Moreover, the retrieval of sensor data from the loggers typically occurs post-process, i.e., after the drilling or production operation is complete. In another example, the monitor receives sensor data via data transmission systems (e.g., acoustic data transmission) that are coupled to the sensors. Such systems are disadvantageous as the sensor data received by the monitor is semi real-time (e.g., once a day, once in 12 hours, and the like) due to low transmission rates and power constraints of the data transmission system.

Thus, there is a need for an enhanced marine riser management system.

### BRIEF DESCRIPTION

In accordance with one aspect of the present technique, a method includes receiving sensor data from a first set of sensors mechanically coupled to a first riser joint of a marine riser. The method also includes analyzing the sensor data to determine a condition of the first riser joint and determining whether the condition satisfies a transmission criterion. The method further includes sending a notification including the condition to an on-vessel monitor communicatively coupled to the marine riser in response to determining that the condition satisfies the transmission criterion.

In accordance with one aspect of the present systems, a system includes a communication module configured to receive sensor data from a first set of sensors mechanically coupled to a first riser joint. The system also includes an analysis module configured to analyze the sensor data to determine a condition of the first riser joint. The system also includes a decision module configured to determine whether the condition satisfies a transmission criterion. The system further includes a notification module configured to send a notification including the condition to an on-vessel monitor communicatively coupled to the marine riser in response to determining that the condition satisfies the transmission criterion.

In accordance with one aspect of the present technique, a computer program product encoding instructions is disclosed. The instructions when executed by a processor, causes the processor to receive sensor data from a first set of sensors mechanically coupled to a first riser joint of a marine riser. The instructions further cause the processor to analyze the sensor data to determine a condition of the first riser joint and determine whether the condition satisfies a transmission criterion. The instructions further cause the processor to send a notification including the condition to an on-vessel monitor communicatively coupled to the marine riser in response to determining that the condition satisfies the transmission criterion.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating a riser management system according to one embodiment;

FIG. 2 is a block diagram illustrating a data transmission device coupled to a riser joint according to one embodiment;

FIG. 3 is a graphical representation of vibrational mode shapes of a marine riser according to one embodiment; and

FIG. 4 is a flow diagram of a method for transmitting sensor data of a riser joint according to one embodiment.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

As used herein, the term “non-transitory computer-readable media” is intended to be representative of any tangible computer-based device implemented in any method or technology for short-term and long-term storage of information, such as computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “software” and “firmware” are interchangeable, and may include any computer program stored in memory for execution by devices that include, without limitation, mobile devices, clusters, personal computers, workstations, clients, and servers.

As used herein, the term “computer” and related terms, e.g., “computing device”, are not limited to integrated circuits referred to in the art as a computer, but broadly refers to at least one microcontroller, microcomputer, programmable logic controller (PLC), application specific integrated circuit, and other programmable circuits, and these terms are used interchangeably herein.

Approximating language, as used herein throughout the description and claims, may be applied to modify any quantitative representation that could permissibly vary without resulting in a change in the basic function to which it is related. Accordingly, a value modified by a term or terms, such as “about” and “substantially”, are not limited to the precise value specified. In at least some instances, the approximating language may correspond to the precision of an instrument for measuring the value. Here and throughout the specification and claims, range limitations may be combined and/or inter-changed, such ranges are identified and include all the sub-ranges contained therein unless context or language indicates otherwise.

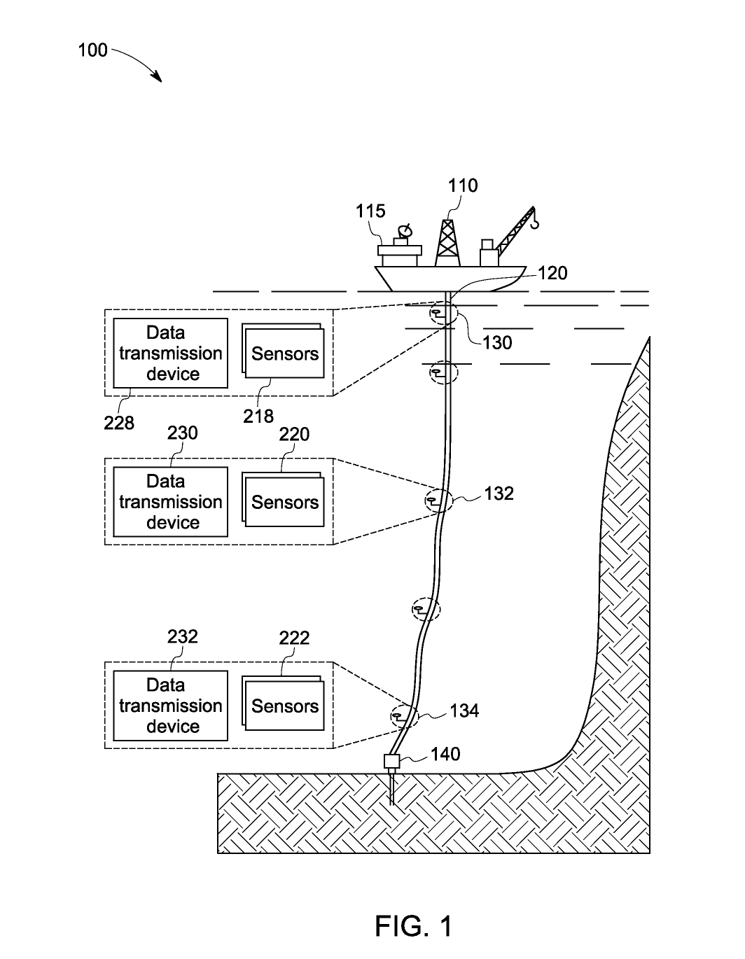

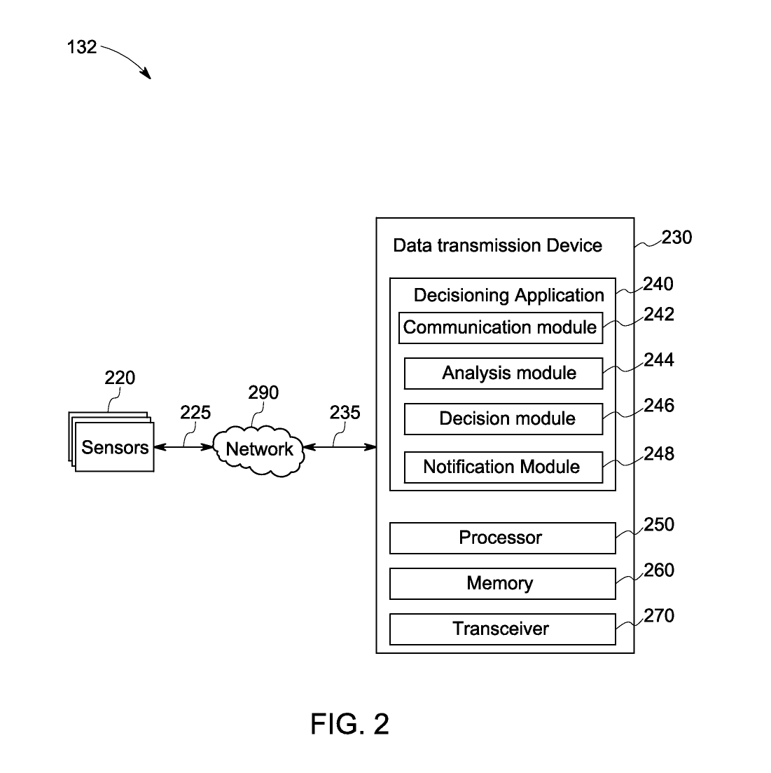

A system and method for transmitting sensor data of a marine riser is described herein. FIG. 1 illustrates a block diagram of a riser management system 100 according to one embodiment. In the illustrated embodiment, the riser management system 100 includes a vessel 110, a marine riser 120, and a well head 140. The vessel 110 may be any type of ship or platform floating on the ocean surface configured to perform offshore drilling of hydrocarbons and production operations. In the illustrated embodiment, the vessel 110 further includes an on-vessel monitor 115 configured to receive a condition and/or sensor data of the marine riser 120 via a transceiver (not shown). The on-vessel monitor 115 may include a processor, a memory, and a display device for further processing and displaying the condition and/or sensor data to, for example, a drilling contractor, an administrator of the riser management system 100, and the like. In one embodiment, the on-vessel monitor 115 may be further configured to send the condition and/or sensor data to an on-shore monitor (not shown) for further analytics of, for example, an oil leak situation, a riser replacement requirement, and the like. The sensor data and the condition are described below in further detail with reference to FIG. 2.

The marine riser 120 may be a vertical structure that acts as a sealed pathway between the vessel 110 and the well head 140 on the ocean surface. In one embodiment, the marine riser 120 may be a drilling riser that is used for, for example, pumping down lubricants, extracting drilling mud and drill cuttings, and the like, during drilling operations. In another embodiment, the marine riser 120 may be a production riser that is used for, for example, extracting hydrocarbons from the ocean floor. In the illustrated embodiment, the marine riser 120 includes a plurality of riser joints 130, 132 and 134 that are connected to the each other by, for example, bolted flanges. Each riser joint 130, 132, and 134 is mechanically coupled to a plurality of sensors (218, 220, and 222 respectively) and a data transmission device (228, 230, and 232 respectively) for sending a condition and/or sensor data of the riser joint 130, 132, and 134 to the on-vessel monitor 115.

FIG. 2 illustrates a plurality of sensors 220 and a data transmission device 230 mechanically coupled to the riser joint 132 according to the embodiment of FIG. 1. The data transmission device 230 and the plurality of sensors 220 are communicatively coupled to each other via a network 290. The network 290 may be a wired or wireless communication type, and may have any number of configurations such as a star configuration, token ring configuration, or other known configurations. Furthermore, the network 290 may include a local area network (LAN), a wide area network (WAN) (e.g., the Internet), and/or any other interconnected data path across which multiple devices may communicate. In one embodiment, the network 290 may be a peer-to-peer network. The network 290 may also be coupled to or include portions of a telecommunication network for transmitting data in a variety of different communication protocols. In another embodiment, the network 290 includes Bluetooth communication networks or a cellular communications network for transmitting and receiving data such as via a short messaging service (SMS), a multimedia messaging service (MMS), a hypertext transfer protocol (HTTP), a direct data connection, WAP, email, and the like. While only one network 290 is shown coupled to the plurality of sensors 220 and the data transmission device 230, a plurality of networks 290 may be coupled to the entities.

The plurality of sensors 220 may include any type of sensors that are configured to measure one or more physical parameters of the riser joint 132. In one embodiment, the plurality of sensors 220 includes one or more strain gauges configured to measure the strain of the riser joint 132. In another embodiment, the plurality of sensors 220 includes an accelerometer/motion sensor configured to measure, for example, a displacement, velocity, an acceleration, and the like, of the riser joint 132. In yet another embodiment, the plurality of sensors 220 includes a curvature sensor/inclinometer configured to measure a roll and pitch angle of the riser joint 132. The plurality of sensors 220 is further configured to send the sensor data (i.e., strain data, displacement, pitch angle, and the like) to the data transmission device 230 via the network 290. The plurality of sensors 220 are coupled to the network 290 via a signal line 225. Although in the illustrated embodiment, a plurality of sensors 220 are shown, in other embodiments, a single sensor may be coupled to the riser joint 132.

The data transmission device 230 may be any device that is configured to analyze the sensor data received from the plurality of sensors 220 and transmit the sensor data and/or a condition of the riser joint 132 to the on-vessel monitor 115. The data transmission device 230 includes a decisioning application 240, a processor 250, a memory 260, and a transceiver 270. The decisioning application 240 includes a communication module 242, an analysis module 244, a decision module 246, and a notification module 248. The plurality of modules of the decisioning application 240, the processor 250, the memory 260, and the transceiver 270 may be coupled to a bus (not shown) for communication with each other. The data transmission device 230 is coupled to the network 290 via a signal line 235. Although in the illustrated embodiment, one data transmission device 230 is shown, in other embodiments, a plurality of data transmission devices may be coupled to the riser joint 132.

The processor 250 may include at least one arithmetic logic unit, microprocessor, general purpose controller or other processor arrays to perform computations, and/or retrieve data stored on the memory 260. In another embodiment, the processor 250 is a multiple core processor. The processor 250 processes data signals and may include various computing architectures including a complex instruction set computer (CISC) architecture, a reduced instruction set computer (RISC) architecture, or an architecture implementing a combination of instruction sets. The processing capability of the processor 250 in one embodiment may be limited to supporting the retrieval of data and transmission of data. The processing capability of the processor 250 in another embodiment may also perform more complex tasks, including various types of feature extraction, modulating, encoding, multiplexing, and the like. In other embodiments, other type of processors, operating systems, and physical configurations are also envisioned.

The memory 260 may be a non-transitory storage medium. For example, the memory 260 may be a dynamic random access memory (DRAM) device, a static random access memory (SRAM) device, flash memory or other memory devices. In one embodiment, the memory 260 also includes a non-volatile memory or similar permanent storage device, and media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices.

The memory 260 stores data that is required for the decisioning application 240 to perform associated functions. In one embodiment, the memory 260 stores the modules (e.g., the communication module 242, the decision module 246, and the like) of the decisioning application 240. In another embodiment, the memory 260 stores transmission criteria (e.g., a stress threshold value, a criterion mode shape, a fatigue threshold value, and the like) that are defined by, for example, a drilling operator, an administrator of the data transmission device 230 or the riser management system 100. The transmission criteria are described below in further detail with reference to the decisioning application 240.

The transceiver 270 is any device configured to receive any sensor data from the plurality of sensors 220 and send the sensor data and/or condition of the riser joint 132 to the on-vessel monitor 115. The transceiver 270 may include any type of data communication, for example, acoustic communication, optical communication, electromagnetic communication, hardwired communication, and the like.

The communication module 242 includes codes and routines configured to handle communications between the plurality of sensors 220 and the other modules of the decisioning application 240. In one embodiment, the communication module 242 includes a set of instructions executable by the processor 250 to provide the functionality for handling communications between the plurality of sensors 220 and the other modules of the decisioning application 240. In another embodiment, the communication module 242 is stored in the memory 260 and is accessible and executable by the processor 250. In either embodiment, the communication module 242 is adapted for communication and cooperation with the processor 250 and other modules of the decisioning application 240.

In one embodiment, the communication module 242 receives sensor data from the plurality of the sensors 220 via the network 290. For example, the communication module 242 receives the sensor data in real-time at a data sampling rate of at least 10 hertz. In another example, the communication module 242 receives the sensor data in response to sending a request for sensor data to the plurality of sensors 220. The sensor data received from the plurality of sensors 220 includes, for example, strain data, a displacement, a velocity, an acceleration, a roll angle and a pitch angle of the riser joint 132. In another example, the communication module 242 further receives sensor data associated with one or more neighboring riser joints 130 and 134 of the marine riser 120. In such an embodiment, the communication module 242 sends the received sensor data to the analysis module 244. The communication module 242 may also perform analog to digital conversion, noise filtering, and the like, prior to sending the sensor data to the analysis module 244. In another embodiment, the communication module 242 receives a notification including, for example, a condition of the riser joint 132 from the notification module 248. In such an embodiment, the communication module 242 sends the notification to the on-vessel monitor via the transceiver 270.

The analysis module 244 includes codes and routines configured to determine a condition of the riser joint 132 based on the received sensor data. In one embodiment, the analysis module 244 includes a set of instructions executable by the processor 250 to provide the functionality for determining a condition of the riser joint 132. In another embodiment, the analysis module 244 is stored in the memory 260 and is accessible and executable by the processor 250. In either embodiment, the analysis module 244 is adapted for communication and cooperation with the processor 250 and other modules of the decisioning application 240.

The analysis module 244 analyzes the sensor data received from the communication module 242 to determine a condition of the riser joint 132. In one embodiment, the analysis module 244 is further configured to remove noise from the received sensor data prior to determining a condition of the riser joint 132. In one embodiment, the analysis module 244 analyzes the sensor data to determine a stress level as the condition of the riser joint 132. For example, the analysis module 244 calculates the stress level of the riser joint 132 based on the strain data received from the communication module 242. In another example, the analysis module 244 calculates the stress level of the riser joint 132 based on the strain data, the curvature (i.e., the roll and the pitch angle) of the riser joint 132. In a further example, the analysis module 244 calculates the stress level of the riser joint 132 based on a stress amplification factor. The analysis module 244 retrieves the stress amplification factor from the memory 260. The stress amplification factor is dependent on the position/depth of the riser joint 132 in the ocean and is defined by, for example, an administrator of the data transmission device 230.

In another embodiment, the analysis module 244 analyzes the sensor data to determine a vibrational characteristic as the condition of the riser joint 132. The analysis module 244 determines the vibrational characteristic based on at least one of the displacement, the velocity, the acceleration, and the strain data of the riser joint 132. The vibrational characteristic of the riser joint 132 includes, for example, a vibrational frequency, a vibrational mode shape, and the like. For example, the analysis module 244 determines the vibrational frequency and the vibrational mode shape of the riser joint 132 based on the strain data, using finite element analysis.

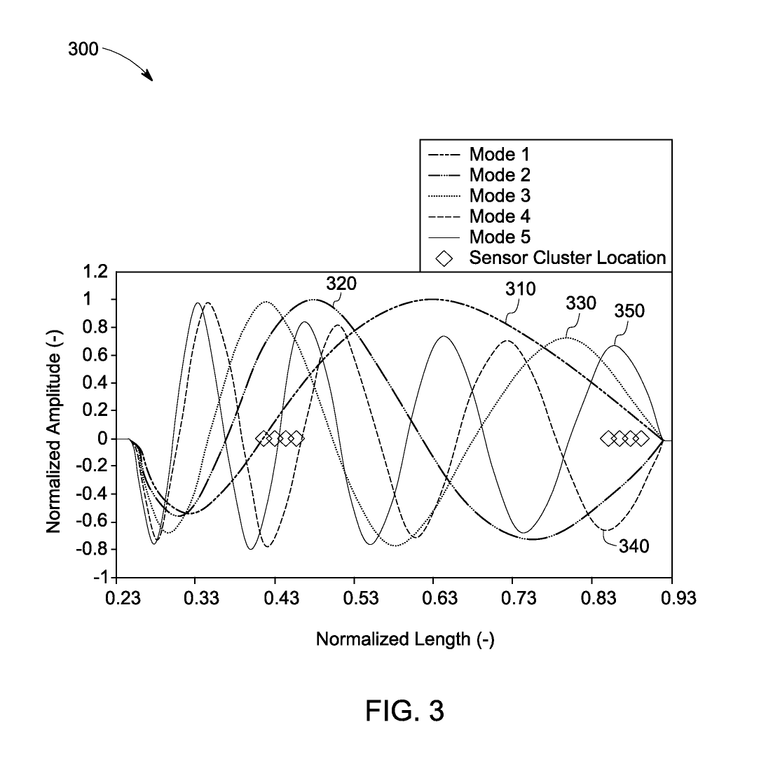

Referring now to FIG. 3, a graphical representation 300 of vibrational mode shapes of a marine riser illustrated according to one embodiment. In the illustrated embodiment, the graph 300 includes curves representing five different vibrational mode shapes (i.e., mode-1 310, mode-2 320. mode-3 330, mode-4 340, and mode-5 350) of a marine riser during drilling operation.

Referring back to FIG. 2, in another embodiment, the analysis module 244 analyzes the sensor data to determine a fatigue level as the condition of the riser joint 132. The analysis module 244 calculates the fatigue level of the riser joint 132 based on at least one of the strain data, the stress level, and the vibrational characteristic of the riser joint 132. In yet another embodiment, the analysis module 244 receives additional sensor data from a plurality of sensors 218, 222 coupled to one or more neighboring riser joints 130, 134. In such an embodiment, the analysis module 244 analyzes the additional sensor data and the sensor data received from the plurality of sensors 220 to determine a condition of the riser joint 132. For example, the analysis module 244 calculates the strain level of the riser joint 132 based on the strain data received from the plurality of sensors 220 and the strain data received from the plurality of sensors 218, 222 coupled to the riser joints 130, 134. In the above described embodiments, the analysis module 244 is further configured to send the condition and the sensor data used to determine the condition, to the decision module 246.

The decision module 246 includes codes and routines configured to determine whether a condition of the riser joint 132 satisfies a transmission criterion. In one embodiment, the decision module 246 includes a set of instructions executable by the processor 250 to provide the functionality for determining whether the condition of the riser joint 132 satisfies the transmission criterion. In another embodiment, the decision module 246 is stored in the memory 260 and is accessible and executable by the processor 250. In either embodiment, the decision module 246 is adapted for communication and cooperation with the processor 250 and other modules of the decisioning application 240.

The decision module 246 receives the condition of the riser joint 132 and determines whether the received condition satisfies the transmission criterion. The decision module 246 retrieves the transmission criterion from the memory 260. The transmission criterion is defined by, for example, a drilling contractor, an administrator of the data transmission device 230, and the like. If the decision module 246 determines that the condition satisfies the transmission criterion, the decision module 246 sends a message to the notification module 248 for sending a notification to the on-vessel monitor 115. The message includes the condition and the sensor data used by the analysis module 244 to determine the condition.

In one embodiment, the decision module 246 receives a stress level of the riser joint 132 and determines whether the received stress level exceeds a stress threshold value (i.e., the transmission criterion). For example, the decision module 246 receives the stress level of the riser joint 132 as 70%. In such an example, the decision module 246 determines that the received stress level exceeds a stress threshold value of 65% and sends a message to the notification module 248.

In another embodiment, the decision module 246 receives a vibrational characteristic of the riser joint 132 and determines whether the vibrational characteristic satisfies a transmission criterion. For example, the decision module 246 receives the vibrational frequency as 7 hertz. In such an example, the decision module 246 determines that the received vibrational frequency is within a frequency threshold range of 5 hertz-10 hertz and sends a message to the notification module 248. In another example, the decision module 246 receives the vibrational mode shape of the riser joint 132 as mode-4 340 (See, FIG. 3). In such an example, the decision module 246 does not send the message to the notification module 248, since the received vibrational mode shape does not match mode-2 320 (See, FIG. 3), i.e., the criterion mode shape.

In yet another embodiment, the decision module 246 receives the fatigue level of the riser joint 132 and determines whether the received fatigue level satisfies a transmission criterion. For example, the decision module 246 receives a fatigue level of the riser joint 132 as 80%. In such an example, the decision module 246 determines that the received fatigue level exceeds a fatigue threshold value of 50% and sends a message to the notification module 248.

The notification module 248 includes codes and routines configured to send a notification to the on-vessel monitor 115. In one embodiment, the notification module 248 includes a set of instructions executable by the processor 250 to provide the functionality for sending the notification to the on-vessel monitor 115. In another embodiment, the notification module 248 is stored in the memory 260 and is accessible and executable by the processor 250. In either embodiment, the notification module 248 is adapted for communication and cooperation with the processor 250 and other modules of the decisioning application 240.

The notification module 248 receives a message from the decision module 246 and sends a notification to the on-vessel monitor 115 via the transceiver 270. In one embodiment, the notification includes the condition (e.g., stress level, a vibrational mode shape, and the like) of the riser joint 132 that satisfies the transmission criterion. In another embodiment, the notification includes the condition of the sensor data and the sensor data used by the analysis module 244 to determine the condition. In yet another embodiment, the notification includes an instruction based on the condition of the riser joint 132. For example, if the decision module 246 determines that the stress level of the riser joint 132 exceeds the threshold stress value (i.e., transmission criteria), the notification module 248 sends a notification including the stress level of the riser joint 132, the sensor data, and an instruction to the on-vessel monitor 115. In such an example, the instruction instructs the on-vessel monitor 115 to adjust the tension of the marine riser 120.

In yet another embodiment, the notification module 248 generates data for providing a user interface including the condition of the riser joint 132 to, for example, a drilling contractor. In such an embodiment, the notification module 248 sends the notification to a display device included in the on-vessel monitor 115. The display device renders the data and graphically displays actionable information to the user interface.

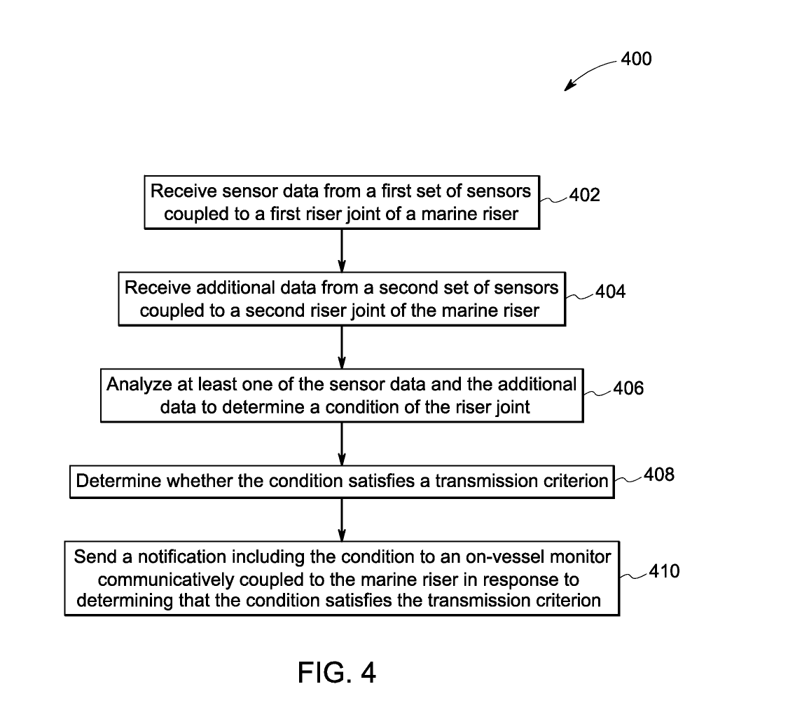

FIG. 4 illustrates a flow diagram 400 of a method for transmitting sensor data of a riser joint according to one embodiment. The communication module receives sensor data from a first set of sensors coupled to a first riser joint of a marine riser 402. For example, the communication module receives strain data and the displacement of the riser joint 132 (See, FIG. 1) from the plurality of sensors in real-time at a data sampling rate of at least 10 hertz. The communication module also receives additional data from a second set of sensors coupled to a second riser joint of the marine riser 404. For example, the communication module receives strain data and displacement of the riser joint 134 (See, FIG. 1) in real-time.

The analysis module analyzes at least one of the sensor data and the additional data to determine a condition of the riser joint 406. In the above example, the analysis module calculates a stress level and a vibrational mode shape of the riser joint 132 (See, FIG. 1) in real-time based on the received sensor data and the additional data. The decision module determines whether the condition of the riser joint satisfies a transmission criterion 408. In the above example, the decision module determines whether the calculated stress level of the riser joint 132 (See, FIG. 1) exceeds a threshold stress value. The decision module further determines whether the calculated vibrational mode shape of the riser joint matches a criterion mode shape. The notification module sends a notification including the condition to an on-vessel monitor communicatively coupled to the marine riser in response to determining that the condition satisfies the transmission criterion 410. In the above example, the notification module sends a notification to the on-vessel monitor as the decision module determines that the calculated vibrational mode shape of the riser joint 132 (See, FIG. 1) matches mode-2 320 (See, FIG. 3), i.e., the criterion mode shape.

The above described riser management system is advantageous compared to conventional riser management systems, as the sensor data is analyzed in real-time for determining a condition of each riser joint of a marine riser. Additionally, instead of sending large amounts of non-interpreted sensor data to the on-vessel monitor, transmitting the condition that satisfies a transmission criterion and the sensor data used to determine the condition, is advantageous due to the low data transmission rates and high power consumption of the existing data transmission systems.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the subject matter has been described in detail in connection with only a limited number of embodiments, it should be readily understood that the inventions are not limited to such disclosed embodiments. Rather, the subject matter can be modified to incorporate any number of variations, alterations, substitutions or equivalent arrangements not heretofore described, but which are commensurate with the spirit and scope of the inventions. Additionally, while various embodiments of the subject matter have been described, it is to be understood that aspects of the inventions may include only some of the described embodiments. Accordingly, the inventions are not to be seen as limited by the foregoing description, but are only limited by the scope of the appended claims. What is claimed as new and desired to be protected by Letters Patent of the United States is:

1. A method comprising:
receiving sensor data from a first set of sensors mechanically coupled to a first riser joint of a marine riser;
analyzing the sensor data to determine a condition of the first riser joint;
determining whether the condition satisfies a transmission criterion; and
sending a notification including the condition to an on-vessel monitor communicatively coupled to the marine riser in response to determining that the condition satisfies the transmission criterion.

2. The method of claim 1, wherein the sensor data includes at least one of a strain data, a displacement, a velocity, an acceleration, a roll angle, and a pitch angle.

3. The method of claim 2, wherein determining the condition further comprises calculating a stress level of the first riser joint based on the strain data.

4. The method of claim 2, wherein determining the condition further comprises calculating a vibrational characteristic of the first riser joint based on the strain data, wherein the vibrational characteristic includes at least one of a vibrational frequency and a vibrational mode shape.

5. The method of claim 4, wherein determining the condition further comprises calculating a fatigue level of the first riser joint based on the vibrational characteristic and the strain data.

6. The method of claim 1, further comprising receiving additional data from a second set of sensors coupled to a second riser joint of the marine riser and determining the condition based on the additional data.

7. The method of claim 1, further comprising receiving the sensor data from the first set of sensors in real-time at a data sampling rate of at least 10 hertz and determining the condition of the first riser joint in real-time.

8. A system comprising:
at least one processor mechanically coupled to a first riser joint of a marine riser;
a communication module stored in a memory and executable by the at least one processor, the communication module configured to receive sensor data from a first set of sensors mechanically coupled to the first riser joint;
an analysis module stored in the memory and executable by the at least one processor, the analysis module communicatively coupled with the communication module and configured to analyze the sensor data to determine a condition of the first riser joint;
a decision module stored in the memory and executable by the at least one processor, the decision module communicatively coupled with the analysis module and configured to determine whether the condition satisfies a transmission criterion; and
a notification module stored in the memory and executable by the at least one processor, the notification module communicatively coupled with the decision module and configured to send a notification including the condition to an on-vessel monitor communicatively coupled to the marine riser in response to determining that the condition satisfies the transmission criterion.

9. The system of claim 8, wherein the first set of sensors includes at least one of strain gauge, a motion sensor, an accelerometer, curvature sensor, and an inclinometer.

10. The system of claim 8, wherein the analysis module further receives strain data from the first set of sensors and calculates a stress level of the first riser joint based on the strain data.

11. The system of claim 10, wherein the analysis module further calculates a vibrational frequency of the first riser joint based on the strain data, wherein the vibrational characteristic includes at least one of a vibrational frequency and a vibrational mode shape.

12. The system of claim 11, wherein the analysis module further calculates a fatigue level of the riser joint based on the vibrational frequency and the strain data.

13. The system of claim 8, wherein the analysis module further receives additional data from a second set of sensors coupled to a second riser joint of the marine riser and determines the condition based on the additional data.

14. The system of claim 8, wherein the analysis module further receives the sensor data from the first set of sensors in real-time at a data sampling rate of at least 10 hertz and determines the condition of the first riser joint in real-time.

15. A computer program product comprising a non-transitory computer readable medium encoding instructions that, in response to execution by at least one processor, cause the processor to perform operations comprising:
receive sensor data from a first set of sensors mechanically coupled to a first riser joint of a marine riser;
analyze the sensor data to determine a condition of the first riser joint;
determine whether the condition satisfies a transmission criterion; and
send a notification including the condition to an on-vessel monitor communicatively coupled to the marine riser in response to determining that the condition satisfies the transmission criterion.

16. The computer program product of claim 15, further causing the processor to calculate a stress level of the riser joint based on strain data received from the first set of sensors.

17. The computer program product of claim 16, further causing the processor to calculate a vibrational characteristic of the riser joint based on the strain data, wherein the vibrational characteristic includes at least one of a vibrational frequency and a vibrational mode shape.

18. The computer program product of claim 17, further causing the processor to calculate a fatigue level of the riser joint based on the vibrational characteristic and the strain data.

19. The computer program product of claim 17, further causing the processor to receive additional data from a second set of sensors coupled to a second riser joint of the marine riser and determine the condition based on the additional data.

20. The computer program product of claim 15, further causing the processor to receive the sensor data from the first set of sensors in real-time at a data sampling rate of at least 10 hertz and determine the condition of the first riser joint in real-time.
